(19) United States
(12) Patent Application Publication
(10) Pub. No.: US 2017/0192646 A1
(43) Pub. Date: Jul. 6, 2017

(54) METHOD AND ELECTRONIC DEVICE FOR HIDING APPLICATION ICONS AND MOBILE PHONE

(71) Applicants: Le Holdings (Beijing) Co., Ltd., Beijing (CN); Lemobile Information Technology (Beijing) Co., Ltd., Beijing (CN)

(72) Inventor: Fan Zhang, Beijing (CN)

(73) Assignees: Le Holdings (Beijing) Co., Ltd., Beijing (CN); Lemobile Information Technology (Beijing) Co., Ltd., Beijing (CN)

(21) Appl. No.: 15/242,842

(22) Filed: Aug. 22, 2016

Related U.S. Application Data
(63) Continuation of application No. PCT/CN2016/088779, filed on Jul. 6, 2016.

(30) Foreign Application Priority Data
Dec. 31, 2015 (CN) 201511032609.8

(51) Int. Cl. G06F 3/0481; G06F 3/0488

(52) U.S. Cl. CPC G06F 3/04817; G06F 3/04886; G06F 3/0482

(57) ABSTRACT

This disclosure provides a method and electronic device for hiding application icons. A method includes the following steps: displaying a hidden mode setting wizard interface according to a user instruction, wherein the wizard interface is used for prompting to set a secret code for entering a hidden mode; when information on the setting completion of the secret code for entering the hidden mode is received, displaying the hidden mode setting interface in which icons of all applications in a normal interface are displayed; when any one of all the application icons is clicked, moving the clicked icon as an application icon to be hidden from the normal interface into a hidden interface, wherein, the hidden interface is used for displaying hidden application icons, and the hidden application icons are not displayed in the normal interface; and when the secret code for entering the hidden mode is received, displaying the hidden interface.

### CROSS REFERENCE TO RELATED APPLICATIONS

This disclosure is a continuation of International Application No. PCT/CN2016/088779 filed on Jul. 6, 2016, which is based upon and claims priority to Chinese Patent Application No. 201511032609.8, filed on Dec. 31, 2015, titled “METHOD AND DEVICE FOR HIDING APPLICATION ICONS AND MOBILE PHONE”, and the entire contents of which are incorporated herein by reference.

### TECHNICAL FIELD

This disclosure relates to the field of computer technologies, and specifically relates to a method, electronic device and a mobile phone for hiding application icons.

### BACKGROUND

At present, with the rapid development of mobile network disclosure, mobile terminals are increasingly more extensively used, provide increasingly more abundant applications, and also provide increasingly more functions. Users can freely install various applications as needed. After an disclosure is installed, an icon of the disclosure will be displayed on an interface, and the disclosure can be run by clicking the application icon.

In some cases, when a user uses a mobile terminal such as a mobile phone, and installs some applications with entertainment functions or with the nature of personal privacy, but the user does not want others to see related application icons or use the related applications. For example, an adult installs some game applications on his mobile phone, but does not want minors to access to these applications, often deletes these applications before the mobile phone is used by the minors, and reinstalls these applications when the mobile phone is used by himself; or additionally sets a password for corresponding applications to prevent others from using the applications. But for the applications with the password, even if the password can prevent others from using the applications, others can still know that the user installs these applications when seeing the application icons.

### SUMMARY

This disclosure discloses a method, electronic device and a mobile phone for hiding application icons to overcome the defects of a method for hiding icons of some applications installed in a mobile terminal in the prior art.

Thus, the embodiments of this disclosure provide the following technical solutions:

One objective of this disclosure is to provide a method for hiding application icons, for use in a mobile terminal, and including the following steps: displaying a hidden mode setting wizard interface according to a user instruction, where the wizard interface is used for prompting to set a secret code for entering a hidden mode; when information on the setting completion of the secret code for entering the hidden mode is received, displaying the hidden mode setting interface in which the icons of all applications in a normal interface are displayed; when any one of the icons of all the applications is clicked, moving the clicked icon as an application icon to be hidden from the normal interface into a hidden interface, where the hidden interface is used for displaying hidden application icons, and the hidden application icons are not displayed in the normal interface; and when the secret code for entering the hidden mode is received, displaying the hidden interface.

Wherein, the method for hiding application icons according to the embodiments of this disclosure further includes a step below, after the hidden interface is displayed: in the hidden interface, returning to the hidden mode setting wizard interface according to the user instruction.

Wherein, the method for hiding application icons according to the embodiments of this disclosure further includes a step of: in the hidden interface, when any one of the hidden application icons is clicked, moving the clicked hidden application icon as an application icon to be moved from the hidden interface into the normal interface.

Wherein, according to the method for hiding application icons according to the embodiments of this disclosure, the hidden mode setting interface is provided with a virtual key for returning to the normal interface, a virtual key for returning to the hidden interface and a virtual key for modifying the secret code, and the method further includes the following steps: when the virtual key for returning to the normal interface is clicked, returning to the normal interface; when the virtual key for returning to the hidden interface is clicked, returning to the hidden interface; and when the virtual key for modifying the secret code is clicked, prompting to modify the secret code.

Where, according to the method for hiding application icons provided in the embodiments of this disclosure, the secret code includes combined key information or password information.

Another objective of the embodiments of this disclosure is to provide a mobile phone including an electronic device for hiding the application icons.

Another objective of the embodiments of this disclosure is to provide an electronic device, including at least one processor and a memory in communication connection with the at least one processor, where the memory stores instructions that can be executed by the at least one processor, and the instructions are executed by the at least one processor to enable the at least one processor to: display a hidden mode setting wizard interface according to a user instruction, where the wizard interface is used for prompting to set a secret code for entering a hidden mode; when information on the setting completion of the secret code for entering the hidden mode is received, display the hidden mode setting interface in which icons of all applications in a normal interface are displayed; when any one of all the application icons is clicked, move the clicked icon as an application icon to be hidden from the normal interface into a hidden interface, where the hidden interface is used for displaying hidden application icons, and the hidden application icons are not displayed in the normal interface; and when the secret code for entering the hidden mode is received, display the hidden interface.

Where, according to the electronic device, after displaying the hidden interface, the method also includes a step of: returning to the hidden mode setting wizard interface according to the user instruction in the hidden interface.

Where, according to the electronic device, in the hidden interface, when any one of the hidden application icons is clicked, the clicked hidden application icon is moved as an application icon to be moved from the hidden interface into the normal interface.

Where, according to the electronic device, the hidden mode setting interface is provided with a virtual key for returning to the normal interface, a virtual key for returning to the hidden interface and a virtual key for modifying the secret code, and the method further includes the following steps: when the virtual key for returning to the normal interface is clicked, returning to the normal interface; when the virtual key for returning to the hidden interface is clicked, returning to the hidden interface; and when the virtual key for modifying the secret code is clicked, prompting to modify the secret code.

Another objective of the embodiments of this disclosure is to provide a non-volatile computer storage medium storing computer executable instructions that, when executed by the electronic device, enable the electronic device to: display a hidden mode setting wizard interface according to a user instruction, where the wizard interface is used for prompting to set a secret code for entering a hidden mode; when information on the setting completion of the secret code for entering the hidden mode is received, display the hidden mode setting interface in which the icons of all applications in a normal interface are displayed; when any one of the icons of all the applications is clicked, move the clicked icon as an application icon to be hidden from the normal interface into a hidden interface, where, the hidden interface is used for displaying hidden application icons, and the hidden application icons are not displayed in the normal interface; and when the secret code for entering the hidden mode is received, display the hidden interface.

Where, according to the non-volatile computer storage medium, after the hidden interface is displayed, the method further includes a step of: in the hidden interface, returning to the hidden mode setting wizard interface according to the user instruction.

Where, according to the non-volatile computer storage medium the method further includes a step of: in the hidden interface, when any one of the hidden application icons is clicked, moving the clicked hidden application icon as an application icon to be moved from the hidden interface into the normal interface.

Where, the hidden mode setting interface is provided with a virtual key for returning to the normal interface, a virtual key for returning to the hidden interface and a virtual key for modifying the secret code, and the method further includes the following steps: when the virtual key for returning to the normal interface is clicked, returning to the normal interface; when the virtual key for returning to the hidden interface is clicked, returning to the hidden interface; and when the virtual key for modifying the secret code is clicked, prompting to modify the secret code.

Where, the secret code includes combined key information or password information.

The technical scheme of the embodiments of this disclosure has the following advantages:

The embodiments of this disclosure provide a method and electronic device for hiding application icons, including the following steps: displaying a hidden mode setting wizard interface according to a user instruction, where the wizard interface is used for prompting to set a secret code for entering a hidden mode; when information on the setting completion of the secret code for entering the hidden mode is received, displaying the hidden mode setting interface in which icons of all applications in a normal interface are displayed; when any one of all the application icons is clicked, moving the clicked icon as an application icon to be hidden from the normal interface into a hidden interface, where the hidden interface is used for displaying hidden application icons and the hidden application icons are not displayed in the normal interface; and when the secret code for entering the hidden mode is received, displaying the hidden interface. The application icons to be hidden are moved from the normal interface into the hidden interface. The hidden application icons cannot be displayed in the normal interface, and can only be seen, started and run in the hidden interface, and the hidden interface can only be displayed when the secret code for entering the hidden mode is received, so as to avoid the application icons to be hidden by a user being seen by others, protect the privacy of the user, and improve the user experience.

### BRIEF DESCRIPTION OF DRAWINGS

One or more embodiments are illustrated by way of example, and not by limitation, in the figures of the accompanying drawings, where elements having the same reference numeral designations represent like elements throughout. The drawings are not to scale, unless otherwise disclosed.

FIG. 1 is a flow diagram of a specific example of a method for hiding application icons in accordance with Embodiment 1 of this disclosure;

FIG. 2 is a functional block diagram of a specific example of an electronic device for hiding application icons in accordance with Embodiment 2 of this disclosure; and

FIG. 3 is a schematic diagram of a hardware structure of the electronic device provided by the embodiments of this disclosure.

### REFERENCE NUMERALS IN THE DRAWINGS

1: Secret code setting unit; 2: Setting interface display unit; 3: First moving unit; 4: Hidden interface display unit: 5: Wizard interface returning unit; 6: Second moving unit; and 7: Interface switching unit.

### DETAILED DESCRIPTION

To make the objectives, the technical scheme and the advantages of the embodiments of this disclosure clearer, the technical scheme of this disclosure will be clearly and completely described hereinafter through implementation with reference to the accompanying drawings in the embodiments of this disclosure. Apparently, the embodiments described below are a part, instead of all, of the embodiments of this disclosure.

### Embodiment 1

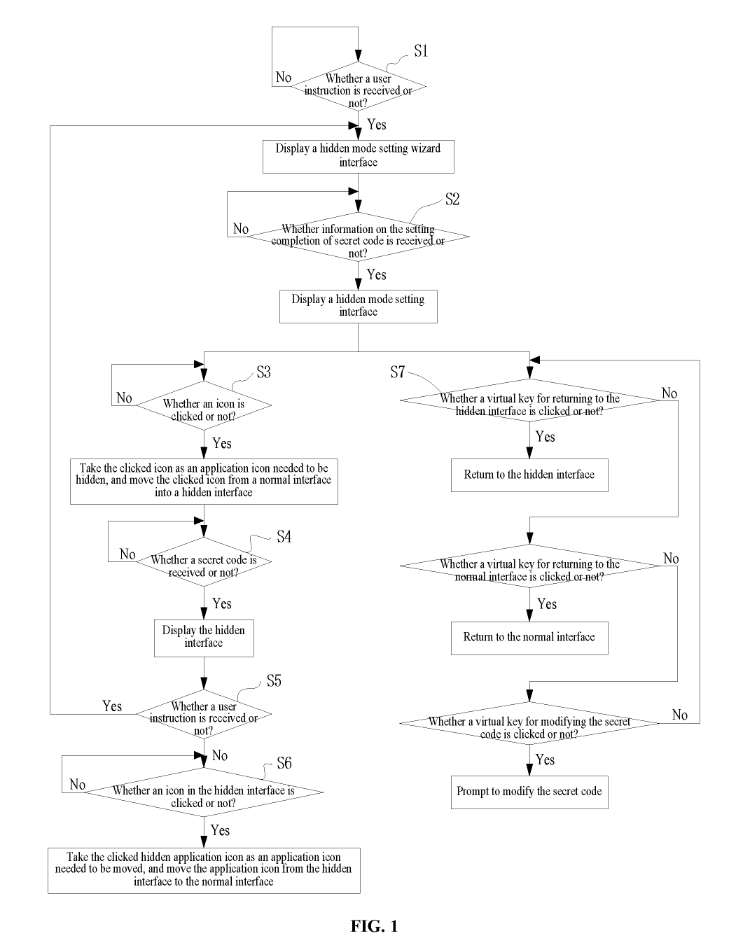

This embodiment provides a method for hiding application icons, for use in a mobile terminal, and specifically, the mobile terminal includes, but is not limited to, a mobile phone, a personal digital assistant (PDA), a palm computer or a tablet computer, etc. A shown in FIG. 1, the method for hiding application icons in this embodiment includes:

S1: a hidden mode setting wizard interface according to a user instruction is displayed, where the wizard interface is used for prompting to set a secret code for entering a hidden mode. Specifically, after an disclosure which can implement the method for hiding application icons in this embodiment is installed in the mobile terminal, an application icon will be displayed in the normal interface of the mobile terminal, and is designated as an APP-D icon. Clicking the APP-D icon by the user can be regarded as receiving a user instruction. The hidden mode setting wizard interface is displayed after the user clicks the APP-D icon, then the wizard interface prompts to set a secret code for entering a hidden mode, and the user can input a secret code to be set by itself in the hidden mode setting wizard interface.

Preferably, the secret code contains combined key information or password information. Specifically, the combined key information may be combined physical key information or combined virtual key information. As long as clickable physical keys or virtual keys on a mobile terminal may be combined, for example, the up and down keys for controlling the volume on the mobile terminal may be selected and combined, and through the hidden mode setting wizard interface, “simultaneously pressing down both of the up and down keys for 5s” is set as a group of combined key information, i.e., a secret code. When triggering information generated by simultaneously pressing both of the up and down keys for 5s is received, it is deemed to receive the secret code; and the password information may be a group of digits or a combination of digits, letters or symbols and the like. For example, “*#*#7777#*#*” may be set as a group of password information, i.e., a secret code, and when triggering information generated by clicking *#*#7777#*#* by a user is received, it is deemed to receive the secret code. Certainly, in addition to the combined key information and password information, the secret code may also be a pattern password, a voice password, an action password and the like, which can be used as the secret code for entering the hidden interface.

S2: when information on the setting completion of the secret code for entering the hidden mode is received, the hidden mode setting interface is displayed, in which icons of all applications in a normal interface are displayed. Specifically, a virtual key may be set in the hidden mode setting wizard interface, and a user needs to click the virtual key after completing setting of a secret code. When the triggering information generated by clicking the virtual key by the user is received, it is deemed to receive the information of the setting completion of the secret code for entering the hidden mode. The icons of all applications in the normal interface are displayed in the hidden mode setting interface, and, the application icons corresponding to any one of or more applications installed in the mobile terminal can be selected as application icons to be hidden through the hidden mode setting interface. After a new disclosure is installed in the mobile terminal, an application icon corresponding to the newly-installed disclosure can also be displayed in the normal interface, the hidden mode setting interface will also be updated with the updating of the application icons in the normal interface, and the user can also select the application icon corresponding to the newly-installed disclosure as an application icon to be hidden through the hidden mode setting interface, so as to meet the real-time needs of the user, and improve the user experience.

S3: when any one of all the application icons is clicked, the clicked icon is moved as an application icon to be hidden from the normal interface into a hidden interface, where the hidden interface is used for displaying hidden application icons, and the hidden application icons are not displayed in the normal interface. Specifically, the hidden application icons cannot be displayed in the normal interface, and are only displayed in the hidden interface, and the applications corresponding to the hidden application icons can only be started and run in the hidden interface, thereby protecting the privacy of the user, and improving the user experience and the information safety.

S4: When the secret code for entering the hidden mode is received, the hidden interface is displayed. Specifically, the hidden interface can only be displayed when the secret code for entering the hidden mode is received, and only the user himself knows the secret code, so as to avoid the hidden interface being invaded by others, and ensure the information safety; moreover, when a user wants to run the applications corresponding to the hidden application icons in the hidden interface, the user may simply input the secret code to enter the hidden interface and click corresponding application icons to start the corresponding applications, thereby facilitating the user operations, and achieving better experience.

Preferably, after the hidden interface is displayed, the method further includes:

S5: the hidden mode setting wizard interface is returned according to the user instruction in the hidden interface. Specifically, when the user instruction is received, that is to say, when the user clicks the APP-D icon for the first time, the hidden mode setting wizard interface is displayed. After completing setting of the secret code, selecting an application icon to be hidden, and moving the application icon to be hidden from the normal interface into the hidden interface, the APP-D icon may be moved into the hidden interface. When the triggering information generated by clicking the APP-D icon in the hidden interface by the user is received, it is deemed to receive the user instruction. At this moment, the terminal returns from the hidden interface to the hidden mode setting wizard interface, and then the user may re-set a new secret code in the wizard interface; and if the user does not need to modify the secret code, the user may directly click a virtual key representing setting completion to enter the hidden mode setting interface, and select a new application icon to be hidden through the hidden mode setting interface, thereby fully considering various needs of the user, and improving the user experience.

Preferably, the method for hiding application icons in this embodiment further includes:

S6: In the hidden interface, when any one of the hidden application icons is clicked, the clicked hidden application icon is moved as an application icon to be moved from the hidden interface into the normal interface. Specifically, when a user does not want to hide some application icons, the user may simply click the hidden application icons in the hidden interface to move the application icons from the hidden interface to the normal interface, so as to adaptively adjust the hidden application icons in the hidden interface according to the user needs, and improve the user experience.

Preferably, the hidden mode setting interface is provided with a virtual key for returning to the normal interface, a virtual key for returning to the hidden interface and a virtual key for modifying the secret code, and the method for hiding application icons in this embodiment further includes:

S7: when the virtual key for returning to the normal interface is clicked, the normal interface is returned; when the virtual key for returning to the hidden interface is clicked, the hidden interface is returned; and when the virtual key for modifying the secret code is clicked, the user is prompted to modify the secret code. Specifically, by setting the virtual key for returning to the normal interface, the virtual key for returning to the hidden interface and the virtual key for modifying the secret code in the hidden mode setting interface, the interface switching among the hidden mode setting interface, the normal interface and the hidden interface is realized, and when the user needs to modify the secret code, the user may simply click the virtual key for modifying the secret code to modify the previously set secret code, thereby meeting various needs of the user, and achieving higher experience.

According to the method for hiding application icons in this embodiment, the application icon to be hidden is moved from the normal interface into the hidden interface, the hidden application icon will no longer be displayed in the normal interface and can only be seen, started and run in the hidden interface, and the hidden interface can only be displayed when the secret code for entering the hidden mode is received, thereby avoiding the application icons to be hidden by a user being seen by others, protecting the privacy of the user, and improving the user experience.

### Embodiment 2

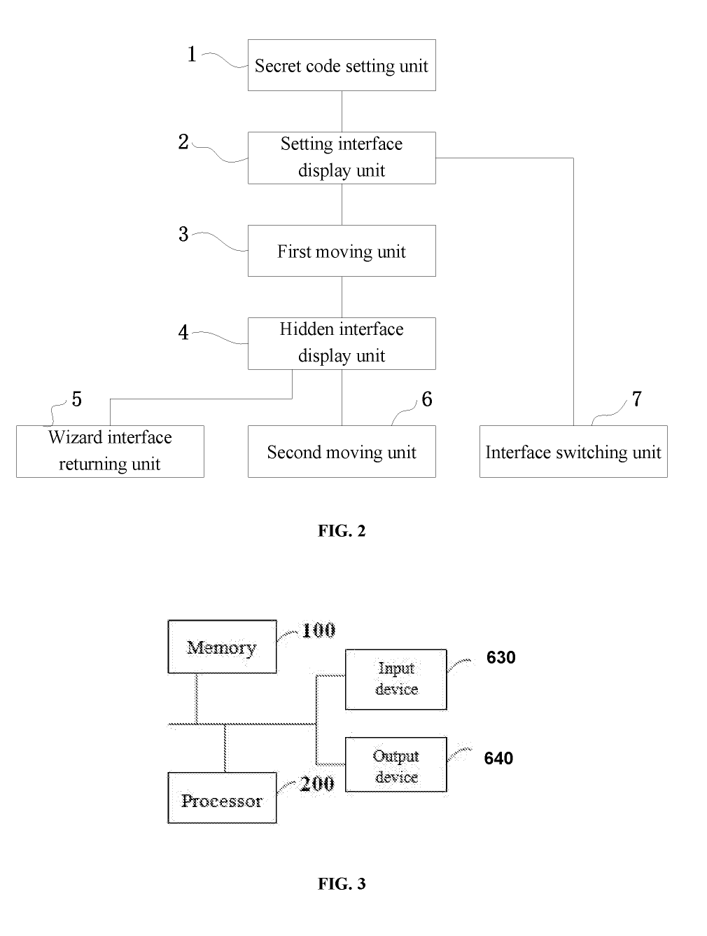

This embodiment provides a device for hiding application icons, for use in a mobile terminal, and as shown in FIG. 2, the device includes:

a secret code setting unit 1, for displaying a hidden mode setting wizard interface according to a user instruction, where the wizard interface is used for prompting to set a secret code for entering a hidden mode.

Preferably, the secret code includes combined key information or password information.

a setting interface display unit 2, for, when information on the setting completion of the secret code for entering the hidden mode is received, displaying the hidden mode setting interface in which icons of all applications in a normal interface are displayed.

a first moving unit 3, for, when any one of all the application icons is clicked, moving the clicked icon as an application icon to be hiddening from the normal interface into a hidden interface, where the hidden interface is used for displaying hidden application icons, and the hidden application icons are not displayed in the normal interface. And

a hidden interface display unit 4, for, when the secret code for entering the hidden mode is received, displaying the hidden interface.

Preferably, the device for hiding application icons in this embodiment further includes:

a wizard interface returning unit 5, for returning to the hidden mode setting wizard interface according to the user instruction in the hidden interface.

Preferably, the device for hiding application icons in this embodiment further includes:

a second moving unit 6, for, in the hidden interface, when any one of the hidden application icons is clicked, moving the clicked hidden application icon as an application icon to be moved from the hidden interface into the normal interface.

Preferably, the hidden mode setting interface is provided with a virtual key for returning to the normal interface, a virtual key for returning to the hidden interface and a virtual key for modifying the secret code, and the device further includes:

an interface switching unit 7, for, when the virtual key for returning to the normal interface is clicked, returning to the normal interface; when the virtual key for returning to the hidden interface is clicked, returning to the hidden interface; and when the virtual key for modifying the secret code is clicked, prompting to modify the secret code.

The device for hiding application icons in this embodiment moves the application icon to be hidden from the normal interface into the hidden interface. The hidden application icon can no longer be displayed in the normal interface, and can only be seen, started and run in the hidden interface, and the hidden interface can only be displayed when the secret code for entering the hidden mode is received, so as to avoid the application icons to be hidden by a user being seen by others, protect the privacy of the user, and improve the user experience.

### Embodiment 3

This embodiment provides a mobile phone, including the device for hiding application icons in accordance with Embodiment 2.

The mobile phone in this embodiment can move the application icon to be hidden from the normal interface into the hidden interface. The hidden application icon can no longer be displayed in the normal interface, and can only be seen, started and run under the hidden interface, and the hidden interface can only be displayed when the secret code for entering the hidden mode is received, so as to avoid the application icons to be hidden by a user being seen by others, protect the privacy of the user, and improve the user experience.

### Embodiment 4

The embodiment of this disclosure provides a non-volatile computer storage medium storing computer executable instructions that, when executed by the electronic device, enable the electronic device to: display a hidden mode setting wizard interface according to a user instruction, where the wizard interface is used for prompting to set a secret code for entering a hidden mode; when information on the setting completion of the secret code for entering the hidden mode is received, display the hidden mode setting interface in which the icons of all applications in a normal interface are displayed; when any one of the icons of all the applications is clicked, move the clicked icon as an application icon to be hidden from the normal interface into a hidden interface, where the hidden interface is used for displaying hidden application icons, and the hidden application icons are not displayed in the normal interface; and when the secret code for entering the hidden mode is received, display the hidden interface.

As a preferred implementation, after the hidden interface is displayed, the method further includes a step of returning to the hidden mode setting wizard interface according to the user instruction, in the hidden interface.

As a preferred implementation, the non-volatile computer storage medium also includes: in the hidden interface, when any one of the hidden application icons is clicked, moving the clicked hidden application icon as an application icon to be moved from the hidden interface into the normal interface.

As a preferred implementation, the hidden mode setting interface is provided with a virtual key for returning to the normal interface, a virtual key for returning to the hidden interface and a virtual key for modifying the secret code, and the method also includes the following steps: when the virtual key for returning to the normal interface is clicked, returning to the normal interface; when the virtual key for returning to the hidden interface is clicked, returning to the hidden interface; and when the virtual key for modifying the secret code is clicked, prompting to modify the secret code.

As a preferred implementation, the secret code includes combined key information or password information.

### Embodiment 5

FIG. 3 shows a schematic diagram of a hardware structure of the electronic device for executing the method for resource allocation in the embodiment of this disclosure, and as shown in FIG. 3, the device includes one or more processors 200 and a memory 100, and one processor 200 is taken as an example in FIG. 3; and the device for executing the method for hiding application icons may also include an input device 630 and an output device 640.

The processor 200, the memory 100, the input device 630 and the output device 640 may be connected with a bus or in other ways, and bus connection is taken as an example in FIG. 3.

The memory 100, as a non-volatile computer readable storage medium, may be used for storing non-volatile software programs, non-volatile computer executable programs and modules, for example, program instructions/modules (e.g., a secret code setting unit 1, a setting interface display unit 2, a first moving unit 3, a hidden interface display unit 4, a wizard interface returning unit 5, a second moving unit 6 and an interface switching unit 7 shown in FIG. 2) corresponding to the method for hiding application icons in the embodiments of this disclosure. The processor 200 runs the non-volatile software programs, instructions and modules stored in the memory 100, so as to execute various functional applications and data processing of a server, thereby implementing the method for hiding application icons in the abovementioned embodiments of the method.

The memory 100 may include a program storage area and a data storage area, where the program storage area may store an operating system and applications for at least one functions; and the data storage area may store data and the like created according to the use of the device for hiding application icons. Moreover, the memory 100 may include a high-speed random access memory, and may also include a non-volatile memory, for example, at least one disk storage device, a flash memory, or other non-volatile solid storage devices. In some embodiments, the memory 100 optionally includes memories that are set remotely relative to the processor 200, and these remote memories may be connected to the device for hiding application icons through a network. An example of the network includes, but is not limited to, internet, intranet, LAN, mobile communication network, and the combinations thereof.

The input device 630 may receive input digit or character information, and generate a key signal input related to the user configuration and function control of the device for hiding application icons. The output device 640 may include display devices such as a display screen.

The one or more modules are stored in the memory 100, and when executed by the one or more processors 200, perform the method for hiding application icons in any one of the abovementioned embodiments of the method.

The abovementioned product can perform the method provided by the embodiments of this disclosure and has corresponding functional modules and beneficial effects for executing the method. For those technical details that not described in this embodiment, please refer to the method provided by the embodiments of this disclosure.

The electronic device of the embodiments of this disclosure exists in many forms, including but not limited to the following devices:

(1) Mobile communication devices: the characteristics of such devices are that they have mobile communication functions with a main objective of enabling voice and data communication. Such terminals include: smart phones (such as iPhone), multimedia phones, feature phones, low-end phones, etc.

(2) Ultra-mobile personal computer devices: such devices belong to the category of personal computers, have computing and processing functions, and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, smart toys, and portable vehicle navigation devices.

(4) Servers: devices providing computing services. The structure of a server includes a processor, a hard disk, an internal memory, a system bus, etc. A server has architecture similar to that of a general purpose computer, but in order to provide highly reliable services, the server has higher requirements in aspects of processing capability, stability, reliability, security, expandability, manageability, etc.

(5) Other electronic devices having data interaction function.

The abovementioned device embodiments are only illustrative, where the units described as separate parts may be or may not be physically separated, the components shown as units may be or may not be physical units, i.e. may be located in one place, or may be distributed at multiple network units. According to actual requirements, part of or all of the modules may be selected to realize the objectives of the technical scheme of the embodiment.

By abovementioned descriptions of the implementations, those skilled in the art can clearly understand that various embodiments may be implemented by means of software and a general hardware platform, and of course, may also be implemented by hardware. Based on such understanding, the abovementioned technical scheme in essence, or the part thereof making contribution to a related technology, may be embodied in the form of a software product, and such computer software product may be stored in a computer readable storage medium such as an ROM/RAM, a magnetic disk or an optical disk, etc., including a number of instructions to enable a computer device (which may be a personal computer, a server, or a network device, etc.) to execute the methods in accordance with various embodiments or some parts thereof.

Finally, it should be noted that: the abovementioned embodiments are merely illustrated for describing rather than limiting the technical scheme of this disclosure; although detailed description of this disclosure is given with reference to the abovementioned embodiments, those skilled in the art should understand that they still can modify the technical scheme recorded in the abovementioned various embodiments or replace part of the technical features therein with equivalents; and these modifications or replacements would not cause the essence of the corresponding technical scheme to depart from the spirit and scope of the technical scheme of various embodiments of this disclosure.

What is claimed is:

1. A method for hiding application icons, used in a mobile terminal, characterized in comprising the following steps:
displaying a hidden mode setting wizard interface according to a user instruction, wherein the wizard interface is used for prompting to set a secret code for entering a hidden mode;
when information on the setting completion of the secret code for entering the hidden mode is received, displaying the hidden mode setting interface in which the icons of all applications in a normal interface are displayed;
when any one of the icons of all the applications is clicked, moving the clicked icon as an application icon to be hidden from the normal interface into a hidden interface, wherein, the hidden interface is used for displaying hidden application icons, and the hidden application icons are not displayed in the normal interface; and
when the secret code for entering the hidden mode is received, displaying the hidden interface.

2. The method for hiding application icons according to claim 1, characterized in further comprising a step below, after the hidden interface is displayed:
in the hidden interface, returning to the hidden mode setting wizard interface according to the user instruction.

3. The method for hiding application icons according to claim 1, characterized in further comprising a step of:
in the hidden interface, when any one of the hidden application icons is clicked, moving the clicked hidden application icon as an application icon to be moved from the hidden interface into the normal interface.

4. The method for hiding application icons according to claim 1, characterized in that the hidden mode setting interface is provided with a virtual key for returning to the normal interface, a virtual key for returning to the hidden interface and a virtual key for modifying the secret code, and the method further comprises the following steps:
when the virtual key for returning to the normal interface is clicked, returning to the normal interface; when the virtual key for returning to the hidden interface is clicked, returning to the hidden interface; and when the virtual key for modifying the secret code is clicked, prompting to modify the secret code.

5. The method for hiding application icons according to claim 1, characterized in that the secret code comprises combined key information or password information.

6. An electronic device, characterized in comprising at least one processor, and a memory in communication connection with the at least one processor, wherein the memory stores instructions that can be executed by the at least one processor, and the instructions are executed by the at least one processor to enable the at least one processor to:
display a hidden mode setting wizard interface according to a user instruction, wherein the wizard interface is used for prompting to set a secret code for entering a hidden mode;
when information on the setting completion of the secret code for entering the hidden mode is received, display the hidden mode setting interface in which icons of all applications in a normal interface are displayed;
when any one of all the application icons is clicked, move the clicked icon as an application icon to be hidden from the normal interface into a hidden interface, wherein the hidden interface is used for displaying hidden application icons, and the hidden application icons are not displayed in the normal interface; and
when the secret code for entering the hidden mode is received, display the hidden interface.

7. The electronic device according to claim 6, characterized in further comprising a step below, after the hidden interface is displayed: in the hidden interface, returning to the hidden mode setting wizard interface according to the user instruction.

8. The electronic device according to claim 6, characterized in that, in the hidden interface, when any one of the hidden application icons is clicked, the clicked hidden application icon is moved as an application icon to be moved from the hidden interface into the normal interface.

9. The electronic device for hiding application icons according to claim 6, characterized in that the hidden mode setting interface is provided with a virtual key for returning to the normal interface, a virtual key for returning to the hidden interface and a virtual key for modifying the secret code, and the method further comprises the following steps: when the virtual key for returning to the normal interface is clicked, returning to the normal interface; when the virtual key for returning to the hidden interface is clicked, returning to the hidden interface; and when the virtual key for modifying the secret code is clicked, prompting to modify the secret code.

10. A non-volatile computer storage medium storing computer executable instructions, characterized in that, the computer executable instructions, when executed by an electronic device, enable the electronic device to: display a hidden mode setting wizard interface according to a user instruction, wherein the wizard interface is used for prompting to set a secret code for entering a hidden mode; when information on the setting completion of the secret code for entering the hidden mode is received, display the hidden mode setting interface in which the icons of all applications in a normal interface are displayed; when any one of the icons of all the applications is clicked, move the clicked icon as an application icon to be hidden from the normal interface into a hidden interface, wherein the hidden interface is used for displaying hidden application icons, and the hidden application icons are not displayed in the normal interface; and when the secret code for entering the hidden mode is received, display the hidden interface.

11. The non-volatile computer storage medium according to claim 10, characterized in further comprising a step below, after the hidden interface is displayed: in the hidden interface, returning to the hidden mode setting wizard interface according to the user instruction.

12. The non-volatile computer storage medium according to claim 10, characterized in further comprising a step of: in the hidden interface, when any one of the hidden application icons is clicked, moving the clicked hidden application icon as an application icon to be moved from the hidden interface into the normal interface.

13. The non-volatile computer storage medium according to claim 10, characterized in that the hidden mode setting interface is provided with a virtual key for returning to the normal interface, a virtual key for returning to the hidden interface and a virtual key for modifying the secret code, and the method further comprises the following steps: when the virtual key for returning to the normal interface is clicked, returning to the normal interface; when the virtual key for returning to the hidden interface is clicked, returning to the hidden interface; and when the virtual key for modifying the secret code is clicked, prompting to modify the secret code.

14. The non-volatile computer storage medium according to claim 10, characterized in that the secret code comprises combined key information or password information.
